(19) United States
(12) Patent Application Publication
(10) Pub. No.: US 2026/0367636 A1
(43) Pub. Date: Nov. 19, 2026

(54) ROBOT OBSTACLE-BYPASSING CONTROL METHOD BASED ON MAP PROBABILITY INFORMATION

(71) Applicant: AMICRO SEMICONDUCTOR CO.,LTD., Zhuhai, Guangdong (CN)

(72) Inventors: Zexin CHEN, Zhuhai, Guangdong (CN); Zhuobiao CHEN, Zhuhai, Guangdong (CN); Hewen ZHOU, Zhuhai, Guangdong (CN)

(73) Assignee: AMICRO SEMICONDUCTOR CO.,LTD., Zhuhai, Guangdong (CN)

(21) Appl. No.: 19/142,916

(22) PCT Filed: Mar. 18, 2024
(86) PCT No.: PCT/CN2024/082186

§ 371 Date: Jun. 24, 2025

(30) Foreign Application Priority Data
Mar. 23, 2023 (CN) 202310289501.5

(51) Int. Cl. G05D 1/622; G05D 1/242; G05D 1/246

(52) U.S. Cl. CPC G05D 1/622; G05D 1/242; G05D 1/2462

(57) ABSTRACT

A method including: controlling a laser sensor of a robot to perform rotational scanning, collecting one or more obstacle contour points, and obtaining one or more grid cells in which the one or more obstacle contour points are located and occupancy probability values; establishing multiple line segments; for each line segment, selecting, from among the one or more grid cells, an effective obstacle grid cell; performing a curve fitting operation using the effective obstacle grid cell to generate a fitted curve equation for obstacle-avoidance; calculating an obstacle-avoidance target point, to cause the robot to travel from its current position to the obstacle-avoidance target point; and updating the current position each time the robot reaches the obstacle-avoidance target point, and repeating the operations of calculating the obstacle-avoidance target point and updating the current position until the robot reaches a predetermined obstacle-avoidance end point.

### TECHNICAL FIELD

The present disclosure relates to the technical field of laser-based mapping and navigation, and more particularly to a robot obstacle-avoidance control method based on map probability information.

### BACKGROUND

At present, most robotic vacuum cleaners, when performing navigation and obstacle-avoidance operations, typically rely on pre-marked obstacle grid cells in a grid map and obstacle information acquired through physical contact via collision sensors to plan avoidance paths. In such methods, obstacle contours are represented by the grid cells in the grid map.

However, due to inconsistent detection distances of one fixed obstacle (i.e., one target object) scanned by a laser sensor, the laser point cloud data collected at two adjacent time points for the same fixed distance may vary. That is, laser data exhibits jitter error, which generally conforms to a normal distribution. As a result, a single actual location point occupied by a fixed obstacle may be marked as multiple obstacle grid cells in the grid map. This causes the robot to be restricted from entering certain regions that are in fact passable in the physical environment, making it difficult to follow the true contour of the obstacle during navigation.

On the other hand, due to the finite resolution of the grid cells in the grid map, using a single grid cell to represent an actual location point occupied by an obstacle introduces a location error that corresponds to the grid resolution (for example, if the resolution is 10 mm, directly using it to locate an obstacle results in a 10 mm error). As a result, path planning directly based on the grid map introduces grid-induced error, which often leads to the loss of certain obstacle contour points that should have been captured. This may cause the robot to enter areas actually occupied by obstacles, thereby increasing the likelihood of frequent collisions.

### SUMMARY

The present disclosure discloses a robot obstacle-avoidance control method based on map probability information. The specific technical solution is as follows.

The robot obstacle-avoidance control method based on map probability information includes: operation S1, controlling, by a robot, a laser sensor of the robot to perform rotational scanning, collecting one or more obstacle contour points, and obtaining, from a grid map, one or more grid cells in which the one or more obstacle contour points are located and one or more occupancy probability values respectively corresponding to the one or more grid cells; operation S2, establishing multiple line segments on a side of the robot proximate to an obstacle such that each line segment traverses one or more grid cells, containing one or more corresponding obstacle contour points of the obstacle contour points, of the grid cells; operation S3, for each line segment, selecting, from among the one or more grid cells traversed by the line segment that contain the one or more corresponding obstacle contour points, an effective obstacle grid cell based on one or more occupancy probability values corresponding to the one or more grid cells traversed by the line segment; operation S4, performing, by the robot, a curve fitting operation using the effective obstacle grid cell described in operation S3 to generate a fitted curve equation for obstacle-avoidance; operation S5, calculating, by the robot, an obstacle-avoidance target point from the fitted curve equation for obstacle-avoidance based on a position point adjacent to a current position of the robot along a target planning direction, to cause the robot to travel from its current position to the obstacle-avoidance target point; and operation S6, updating the current position of the robot to be the obstacle-avoidance target point each time the robot reaches the obstacle-avoidance target point, and repeating operations S5-S6 until the robot reaches a predetermined obstacle-avoidance end point.

The technical effects achieved by operations S1 to S6 are as follows: The line segments are arranged on the side of the robot proximate to the obstacle; based on the occupancy probability values of the grid cells where the obstacle contour points are located, the effective obstacle grid cell is selected from among the grid cells traversed by the same line segment; these effective obstacle grid cells serve as filtered laser data points from the rotational scanning of the laser sensor, effectively overcoming the jitter error inherent in laser data, and yielding effective occupied positions in the grid map that better represent the obstacle contour. Therefore, operations S1 to S3, by selecting effective obstacle grid cells based on occupancy probability values (belonging to obstacle grid cells), enable the extraction of representative obstacle grid cells within limited grid regions along each line segment with minimal grid search effort; this reduces the negative effects of laser data jitter, thereby decreasing motion constraints on the robot and increasing its chances of approaching the actual obstacle contour. On this basis, curve fitting is performed using the effective obstacle grid cells to generate a fitted curve equation for obstacle-avoidance, thereby fitting a fitted curve for obstacle-avoidance, and smoothing the obstacle grid cells; compared with existing methods that stitch together trajectories directly using grid cells or point cloud data, the proposed curve fitting approach in the embodiments improves the accuracy and smoothness of the planned path, mitigating positioning errors caused by grid resolution and compensating for grid errors introduced by missed contour points. Additionally, the robot sequentially walks to each obstacle-avoidance target point along the fitted curve, and tracks previous position points of the robot along the fitted curve, thereby achieving curve fitting and node tracking based on historical markings of the obstacle contour points, and achieving collision-free obstacle avoidance or bypassing during the tracking process.

### BRIEF DESCRIPTION OF THE DRAWINGS

FIG. 1 is a flowchart illustrating some embodiments of the robot obstacle-avoidance control method based on map probability information.

FIG. 2 is a schematic diagram showing grid cells marking a linear obstacle as scanned by a rotating laser sensor mounted on a robot according to some embodiments.

FIG. 3 is a schematic diagram showing multiple line segments set by the robot passing through the grid cells corresponding to the identified obstacle contour points according to some embodiments.

FIG. 4 is a schematic diagram illustrating how the robot sequentially plans obstacle-avoidance target points along the positive direction of the Yr axis according to some embodiments.

### DETAILED DESCRIPTION

To more clearly describe the present disclosure, specific embodiments are provided below for further illustration. In the following description, specific details such as particular system structures and techniques are presented for purposes of explanation, not limitation, in order to facilitate a thorough understanding of the disclosed embodiments. However, it will be apparent to those skilled in the art that the disclosed embodiments may also be implemented without these specific details. In other instances, well-known systems, devices, circuits, and methods are not described in detail so as not to obscure the description of this disclosure with unnecessary particulars.

It should be understood that the term “comprising,” as used herein, indicates the presence of stated features, components, operations, elements, and/or modules, but does not preclude the presence or addition of one or more other features, components, operations, elements, modules, and/or groups thereof. Furthermore, the term “and/or” as used herein refers to any and all combinations of one or more of the associated listed items and encompasses all possible permutations.

As used herein, the term “if” can be interpreted, depending on context, to mean “when,” “upon,” “in response to determining,” or “in response to detecting.” Similarly, the phrases “if it is determined” or “if it is detected [that a condition or event occurs]” may be interpreted as “once it is determined,” “in response to determining,” “once [the described condition or event] is detected,” or “in response to detecting [the described condition or event].”

Additionally, in the description of the present disclosure, terms such as “first,” “second,” and “third,” are used merely to distinguish between different elements or operations, and are not intended to indicate or imply relative importance. References in this specification to “one embodiment” or “some embodiments” mean that a particular feature, structure, or characteristic described in connection with the embodiment is included in at least one embodiment of the present disclosure. Thus, the phrases “in one embodiment,” “in some embodiments,” “in other embodiments,” and the like may refer to the same or different embodiments, and unless otherwise specified, are not mutually exclusive or collectively exhaustive. The terms “comprise,” “include,” “have,” and variations thereof should be interpreted as open-ended terms meaning “including but not limited to,” unless otherwise specifically stated.

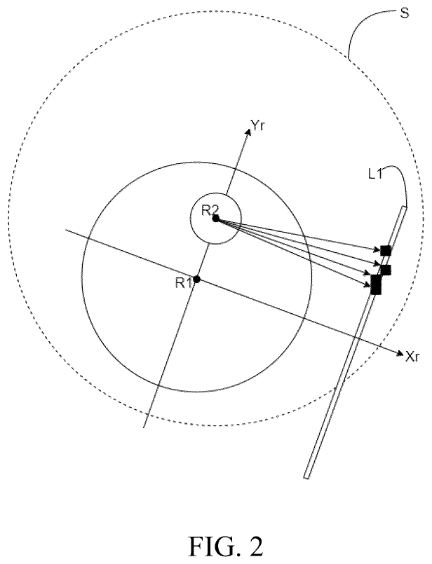

In one embodiment, a robot obstacle-avoidance control method based on map probability information is disclosed. The method is executed by an obstacle-avoiding device, such as a robot. The robot may include, for example, a vacuum cleaner, a guide robot, a patrol robot, or a lawn-mowing robot. As shown in FIG. 2, the robot body may have a disk-shaped structure located to the left of an obstacle L1. The center of the robot body, represented by position point R1, denotes the center of the robot's projected area on a planar surface. A laser sensor (e.g., a LiDAR) is mounted on the robot, represented by a smaller circular structure in FIG. 2 to the left of obstacle L1. The center of the laser sensor is represented by position point R2. The laser sensor performs rotational scanning within an effective detection range (bounded by the dashed circle S in FIG. 2) to detect obstacles and supports the construction of a grid map based on the surrounding environment scanned by the robot. The robot then uses this grid map to localize both itself and nearby obstacles based on their pose information.

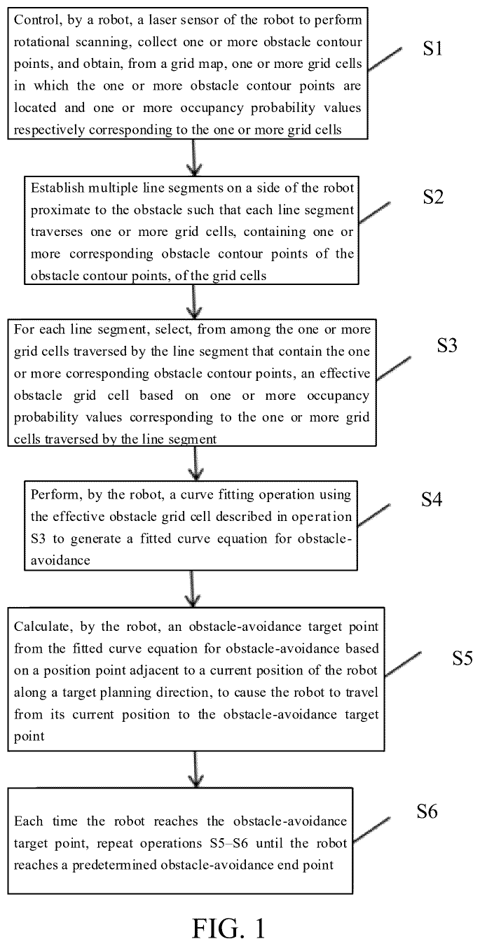

As shown in FIG. 1, the robot obstacle-avoidance control method includes the following.

In operation S1: The robot controls the laser sensor to perform rotational scanning. A laser probe within the laser sensor emits laser beams and rotates 360 degrees around the center of the laser sensor to collect obstacle contour points. As a result of the rotational scanning, the robot can collect multiple obstacle contour points in a single scan. The robot then identifies the grid cells on the map where these obstacle contour points fall and retrieves the corresponding occupancy probability values. Next, operation S2 is executed. In operation S1, each full rotation of the laser probe provides the robot with 360 point cloud points, recorded as one frame of point cloud data. Each point corresponds to an obstacle contour point of the obstacle at a specific angle. The robot collects obstacle contour points frame by frame and transforms the coordinates of these obstacle contour points in real time into positions on a grid map (composed of unit cells with a certain resolution). This allows the robot to determine the specific grid cells hit by the obstacle contour points and retrieve both the grid coordinates and the hit probability values. Each hit probability value reflects the likelihood that a corresponding grid cell is occupied by an obstacle. Multiple hit probability values are accumulated and recorded as an occupancy probability value, thereby updating the hit probability values assigned to the grid cell where the corresponding obstacle contour points fall to the occupancy probability value. Actually, the occupancy probability value corresponding to the grid cell where the corresponding obstacle contour points fall more accurately represent the possibility that this grid cell is occupied by an obstacle. The coordinates of the obstacle contour points may be defined in a robot coordinate system (a Cartesian coordinate system) centered at the robot body's center. These coordinates are transformed from the point cloud points output by the laser sensor, which are defined in the laser sensor's coordinate system. The laser sensor's coordinate system may be a polar coordinate system, centered at the laser sensor's center (or at the rotation center of the laser probe). The transformation from the laser sensor's coordinate system to the robot's coordinate system is determined based on a rigid connection relationship between the center of laser sensor and the center of the robot body.

This rigid connection relationship may be derived using a trigonometric transformation relationship well known to those skilled in the art. Specifically, the coordinate transformation between the laser coordinate system and the robot coordinate system is given by the following equations:

R_x=dist*cos(theta)+laser_dist*cos(laser_theta);

R_y=dist*sin(theta)+laser_dist*sin(laser_theta);

R_dist=sqrt(R_x²+R_y²);

R_theta=a tan(R_y/R_x);

The polar coordinates of the point cloud points output by the laser sensor (in the laser coordinate system) are denoted as (theta, dist). The polar coordinate data of the obstacle contour point is (R_theta, R_dist), which is defined with respect to the polar coordinate system centered at the robot body center. The polar coordinate of the robot body center relative to the laser sensor center is denoted as (laser_theta, laser_dist). The position coordinate of the obstacle contour point is (R_x, R_y).

It should be noted that the obstacle contour points are reflection points generated when laser beams emitted by the laser sensor are reflected by the surfaces of obstacles located in the vicinity of the side of the robot. These reflection points enable the acquisition of two-dimensional coordinate information and angular information of the detected (or scanned) obstacles.

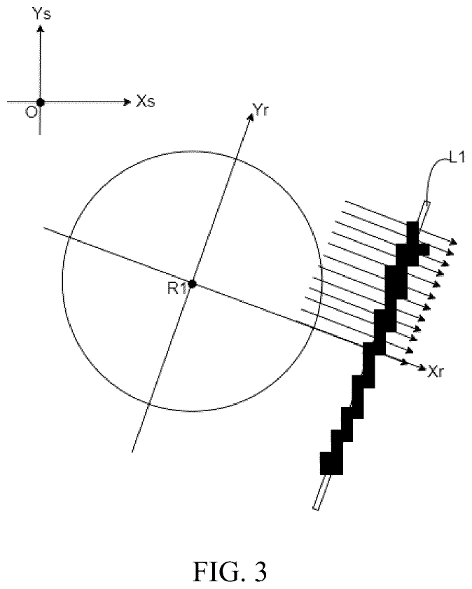

In operation S2: Multiple line segments are set on the side of the robot that is near the obstacle, such that the configured line segments pass through the grid cells in which the obstacle contour points are located. Then, operation S3 is executed. The line segments configured in operation S2 may pass through at least one grid cell containing an obstacle contour point, i.e., at least one obstacle grid cell. Each grid cell containing an obstacle contour point may be marked as an obstacle grid cell. As illustrated by the multiple arrowed line segments (excluding the Xr axis) on the right side of the robot body center R1 in FIG. 3, the multiple arrowed line segments pass through the respective grid cells in which the obstacle contour points of obstacle L1 are located. These grid cells are shown as black cells in FIG. 3. By setting multiple line segments that pass through the grid cells containing the obstacle contour points on the side of the robot near the obstacle, a certain grid area can be delineated within the grid map. Although there are gaps between the different line segments, each line segment has a limited length, thereby forming a search window that uses the line segments as traversal units. Furthermore, the multiple line segments have defined extension directions and, within a certain range of the grid area, can be regarded as rays, thereby enabling the identification of grid cells containing obstacle contour points in clear directions.

Moreover, the multiple line segments set on the side of the robot facing the obstacle are displaced in synchronization with the robot's movement, so as to dynamically and orderly capture the latest traversed contour points of the obstacle outside the robot and on the side of the robot. Since there are gaps between the line segments set by the robot, they do not completely cover the entire area occupied by the obstacle contour. As a result, compared with the obstacle grid cells traversed by the rectangular window in the related art, the number of obstacle contour points passed through by the multiple line segments is reduced.

In operation S3: Among the grid cells in which the obstacle contour points passed through by each line segment are located, effective obstacle grid cells are selected based on the occupancy probability values corresponding to the grid cells of the obstacle contour points. This enables the selection of the effective obstacle grid cells within a defined grid region (i.e., the grid region composed of the grid cells traversed by each line segment in the same grid cell map), thereby forming an effective contour of the obstacle on the grid map that can represent the actual physical position occupied by the obstacle. Then, proceed to operation S4.

In the implementation scenario of operation S3, due to the potential coordinate offset error or angular deviation error of the obstacle contour points collected by the robot in the grid map, a single obstacle contour point obtained from the laser probe rotating one or more times may hit multiple grid cells. This is especially true for the linear obstacle L1 shown in FIG. 3, where the obstacle is perpendicular to the line segment and occupies only the size of a single grid cell in its direction. In reality, the obstacle contour points collected from scanning the linear obstacle L1 will occupy at least two grid cells in a direction perpendicular to the linear obstacle L1 (corresponding to the grid cells where the obstacle contour points are located, represented by the shaded unit squares in FIG. 3). That is, the same obstacle contour point will be repeatedly collected during the laser probe's rotating and scanning process and offset to one side of the linear obstacle L1, hitting at least one additional grid cell. As a result, the actual position point of a fixed obstacle in the grid map may be marked as composed of multiple obstacle grid cells, forming a laser data jitter phenomenon. This causes each line segment (each arrowed line segment passing through obstacle L1 in FIG. 3) to pass through at least two obstacle grid cells in the grid map. Moreover, the probability value of each collected obstacle contour point hitting a specific grid cell follows a normal distribution. Regardless of whether the grid cell's occupancy probability value changes, the robot can be reduced to a point, represented as the position point R1 shown in FIGS. 2 to 4. Of course, the multiple obstacle contour points obtained by rotating the laser probe one or more times may hit the same grid cell; in this case, the hit probability values at the same grid cell location in the grid map, obtained from different actual collected obstacle contour points, are continuously updated to generate the probability information for the grid cell; thus, the occupancy probability value of the grid cell is obtained. As a result, the grid map is updated, and the accumulated hit probability values are replaced by the occupancy probability value, ensuring that the hit probability values assigned to the grid cells containing the obstacle contour points are updated to the occupancy probability value. This makes the updated grid map more accurately reflect the actual position occupied by the obstacle. As the number of rotations of the laser probe increases, the accuracy of the reflected position is improved. Therefore, compared to the related art, this embodiment selects effective obstacle grid cells (those belonging to obstacle grid cells) based on the occupancy probability value of the grid cell corresponding to the obstacle contour point. It can select representative obstacle grid cells in each line segment within a limited grid area, consuming fewer grid searches, and overcoming the impact of laser data jitter.

It is worth noting that a grid map with a certain resolution allows a certain number of point clouds to hit, and the grid map is composed of a certain number of hit grid cells corresponding to these point clouds. In some embodiments, the probability grid cell [Pmin, Pmax] is constructed using a 5 cm*5 cm grid size. Regardless of whether it is a 2D grid map or a 3D grid map, when the map is completed, the occupancy probability value of a grid cell less than Pmin indicates that no obstacle exists at this grid cell location. The value between Pmin and Pmax indicates an unknown status, while a value greater than Pmax indicates that an obstacle exists at this grid cell location. Each frame of laser point clouds generates a batch of grid cells, where each grid cell is assigned a probability value. If the grid cell already has a probability value from a previous frame, the probability value of that grid cell needs to be updated. The above-mentioned occupancy probability value can be used to represent the likelihood that a grid cell is occupied or hit by an obstacle. This embodiment can use methods from related technologies to determine the probability that each grid cell is hit by an obstacle at a given moment, and this will not be elaborated further here.

In operation S4, the robot performs a curve fitting operation using the effective obstacle grid cells obtained in operation S3 to generate a fitted curve equation for obstacle-avoidance, and then proceeds to operation S5.

In operation S4, to fit a curve for the robot's direct use in obstacle-avoidance trajectory planning, the effective obstacle grid cells selected in operation S3 can undergo expansion or translation processing. This operation reduces the distance between the effective contour of the obstacle detected by the laser sensor in the grid map and the side edge of the robot. After the expansion or translation is performed on the effective obstacle grid cells, a curve fitting operation is carried out using the effective obstacle grid cells obtained in operation S3 to generate the fitted curve equation for obstacle-avoidance, and to generate a fitted curve for obstacle-avoidance (which can be viewed as a sequence of discrete points forming this fitted trajectory for obstacle-avoidance) corresponding to the fitted curve equation for obstacle-avoidance. The robot then follows the fitted curve for obstacle-avoidance to navigate around the obstacle. To prevent the robot from colliding with obstacles, the coordinate offset generated by the expansion or translation processing is determined by considering the robot body's radius and the required obstacle-avoidance distance.

Typically, since the obstacle contour points are initially represented using the grid map and the robot directly avoids obstacles based on the grid map, this could lead to grid errors (determined by the resolution of the grid map; here, the grid resolution is 10 mm, so there would be a 10 mm positional error in the obstacle-avoidance operation). As a result, the laser point cloud data detected during the movement of differential-drive robots like vacuum cleaners will exhibit continuous jitter. To address this, in this embodiment, operation S4 applies a curve fitting operation to the effective obstacle grid cells obtained in operation S3, effectively smoothing the effective obstacle grid cells. The resulting fitted curve is smoother than the grid resolution, reducing the error and filling in the missing obstacle contour points caused by grid resolution, thus creating a smoother obstacle contour. This is suitable for planning a robot's parallel edge-following direction.

Furthermore, to track the robot's obstacle-avoidance position points in real-time, the fitted curve equation for obstacle-avoidance is used to sequentially calculate each position point the robot will follow along the fitted curve for obstacle-avoidance. This helps the robot plan the path to navigate from its current position to the fitted curve for obstacle-avoidance.

In operation S5: The robot, based on a neighboring position point in the target planning direction from its current position, calculates an obstacle-avoidance target point using the fitted curve equation for obstacle-avoidance. The robot then proceeds from its current position to the obstacle-avoidance target point. In general, the movement is performed within a traversable area along a predefined direction in a straight line, typically in the forward direction of the robot. The process then continues with operation S6.

If the target planning direction is defined as the positive direction of the vertical axis in the robot's coordinate system, then the robot calculates the obstacle-avoidance target point whose ordinate matches that of the neighboring position point in the planning direction by using the fitted curve equation for obstacle-avoidance. This is equivalent to substituting the ordinate of the neighboring position point into the fitted curve equation for obstacle-avoidance to compute the corresponding abscissa. As a result, the obstacle-avoidance target point's coordinate information within the robot's coordinate system is determined.

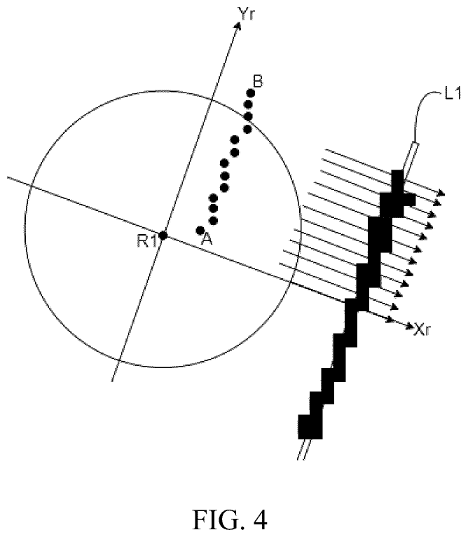

As illustrated in FIG. 4, the robot body's center moves from position point R1 (considered as the robot's current position) to position point A in order to enter the fitted curve for obstacle-avoidance. Position point A is the first obstacle-avoidance target point calculated through the execution of operation S5; based on this, the robot begins at the first obstacle-avoidance target point and proceeds in the target planning direction toward each subsequently calculated obstacle-avoidance target point in real time. This allows the robot to begin traveling along the extension direction of the fitted curve for obstacle-avoidance (which may also be the direction where the coordinate values increase)—without colliding with any obstacles. This movement corresponds to the direction from point A to point B in FIG. 4 and can be regarded as progressing in the positive direction of the Yr axis. Furthermore, this motion assumes that the coordinate distance between the current position and the adjacent position in the target planning direction defines the spacing between two neighboring obstacle-avoidance target points. The robot thus travels along the extension of the fitted curve for obstacle-avoidance accordingly.

In operation S6: Each time the robot reaches an obstacle-avoidance target point, that point is updated as the current position, and operations S5 to S6 are repeated until the robot reaches a predefined obstacle-avoidance end point. Specifically, upon arriving at an obstacle-avoidance target point, the robot updates its current position to that target point, then continues to repeat operations S5 to S6. By continuously utilizing the fitted curve equation for obstacle-avoidance generated in operation S4, the robot tracks and navigates toward the next obstacle-avoidance target point. In this manner, the robot progresses along the extension direction of the fitted curve for obstacle-avoidance, advancing from one target point to the next, until it ultimately reaches the predefined obstacle-avoidance end point.

Upon completion of operation S6, and if necessary, once the robot reaches the end of the currently-fitted curve for obstacle-avoidance segment (generated in operation S4), a new fitted curve for obstacle-avoidance segment may be recalculated using operation S4. This new curve segment may have a different extension direction and curvature. The robot then continues to move along the extension of this newly-generated fitted curve. This enables the robot to continuously track and follow alongside the obstacle, effectively navigating around the obstacle.

The technical effects resulting from the aforementioned operations S1 to S6 are as follows.

In the present embodiment, multiple line segments are arranged on the side of the robot adjacent to the obstacle. Based on the occupancy probability values of the grid cells corresponding to the obstacle contour points, effective obstacle grid cells are selected from the grid cells traversed by each individual line segment within the grid map. These selected effective obstacle grid cells are used to filter the laser data obtained from the rotational scanning of the laser sensor, thereby mitigating the jitter errors inherent in the laser data and enabling the identification of occupied positions within the grid map that effectively represent the obstacle contour. Accordingly, in operations S1 to S3, effective obstacle grid cells (i.e., grid cells corresponding to actual obstacle locations) are selected based on the occupancy probability values of the grid cells associated with the obstacle contour points. This approach allows the representative obstacle grid cells to be identified with a reduced grid search load within a defined grid area for each line segment, thereby overcoming the impact of laser data jitter. As a result, the movement constraints imposed on the robot are reduced, the probability of the robot approaching the obstacle contour is improved, and the robot is able to approach the obstacle contour without collision and stably move along the contour of the obstacle.

On this basis, a curve fitting operation is performed using the effective obstacle grid cells to obtain a fitted curve equation for obstacle-avoidance for the robot's obstacle-avoidance path planning, thereby generating a corresponding fitted curve for obstacle-avoidance. This enables a smoothing process for the obstacle grid cells. Compared with directly stitching a trajectory using grid data or point cloud data, the curve fitting operation of the present embodiment improves the accuracy and smoothness of the fitted trajectory. It overcomes positioning errors caused by grid resolution and compensates for grid errors resulting from uncollected obstacle contour points.

The robot follows the fitted curve for obstacle-avoidance by sequentially moving through each obstacle-avoidance target point, tracking the positions ahead of the robot along the curve. This enables the robot to perform curve fitting and node tracking based on historically marked obstacle contour points, thereby achieving contact-free obstacle-avoidance or navigation around the obstacle during the tracking process.

Based on the foregoing embodiment, a predefined obstacle-avoidance end point is set, which serves as the fitting end point required to generate the fitted curve equation for obstacle-avoidance. Each fitted curve equation for obstacle-avoidance generated in a single execution of operation S4 corresponds to one predefined obstacle-avoidance end point. When the curve fitting operation in operation S4 employs a Bézier curve, the fitting end point used to generate the corresponding fitted curve equation is the end point of the Bézier curve.

Each time the robot reaches a predefined obstacle-avoidance end point, the current position is update as the predefined obstacle-avoidance end point, and operations S1 to S6 are repeated. During the newly executed operation S1, new obstacle contour points are acquired. After the robot reaches the previous predefined obstacle-avoidance end point in the last execution of operation S6, the multiple line segments configured in operation S2 are projected onto a newly uncovered ground area. Consequently, in the new execution of operation S3, new effective obstacle grid cells are collected. By executing operation S4 again, the effective obstacle grid cells traversed by the line segments in this new ground area are subjected to a curve fitting operation to obtain a new fitted curve for obstacle-avoidance. Then, in the new execution of operation S5, new obstacle-avoidance target points are continuously calculated. The robot, by executing operation S6, walks while dynamically updating the obstacle-avoidance curve it follows. Thus, using the most recently fitted curve equation for obstacle-avoidance (e.g., a Bézier curve equation) obtained from the newly executed operation S4, the robot continuously tracks the next obstacle-avoidance target point until it reaches a final navigation end point, thereby bypassing the currently detected fixed obstacle. At this point, the obstacle-avoidance control method is terminated. This dynamic update mechanism enables the robot to continuously follow the latest fitted curve for obstacle-avoidance, facilitating complete avoidance of obstacles by relying on both the predefined obstacle-avoidance end point and the final navigation target. The method allows for the real-time generation of adaptive bypass trajectories based on the spatial characteristics of different obstacles, effectively improving the obstacle-avoidance performance of laser navigation robots.

The obstacle-avoidance target points, predefined obstacle-avoidance end points, and final navigation end points can all be positioned on the side of the line segments set in operation S2 that is away from the obstacle contour points. Among these, the final navigation end point can be set based on the navigation task that the robot is required to perform, and it represents a target location for obstacle-free navigation within the working environment, such as the charging station, robot recovery base, or other designated goal positions.

As an embodiment, in operation S2, multiple parallel line segments are set along the target planning direction on the side of the robot that is near the obstacle. Each line segment is configured to extend towards the grid cell containing the obstacle contour point. The direction in which one endpoint extends towards the other endpoint can be regarded as extending from the grid cell containing the robot's center to the grid cell containing the obstacle contour point. The grid cell containing the obstacle contour point is classified as an obstacle grid cell and is assigned an occupancy probability value to represent the likelihood of being occupied by the obstacle. However, the line segments set in operation S2 are not necessarily perpendicular to the target planning direction. If the predefined detection direction is parallel to the robot's wheel axis, and the predefined detection direction is perpendicular to the target planning direction, the line segments set in operation S2 will not necessarily be parallel to the robot's wheel axis, but will be parallel to the robot's traveling plane, i.e., parallel to the projection of the robot body on its traveling plane. Preferably, as shown in FIG. 3, the line segments set in operation S2 (the arrowed segments passing through obstacle L1, excluding the Xr axis) can be considered parallel to the Xr axis. Each line segment is configured to extend towards the grid cell containing the obstacle contour point, as indicated by the arrow direction along the positive direction of the Xr axis, passing through the grid cell containing the obstacle contour point. Preferably, the predefined detection direction is along the positive direction of the Xr axis, and the side of the robot near the obstacle is also on the side of the preset detection direction of the robot's center R1. Referring to FIGS. 2 to 4, the predefined detection direction is along the positive direction of the Xr axis, and the target planning direction can be selected as the positive direction of the Yr axis. Accordingly, the Xr axis can be set as the horizontal axis of a coordinate system with the robot body's center R1 as the origin, and the Yr axis can be set as the vertical axis of the same coordinate system. In conclusion, this embodiment, based on the target planning direction and the extension direction of the mutually parallel line segments, makes the direction of the grid cell containing the obstacle contour point obtained from the obstacle grid cell more clearly defined, thus avoiding the arbitrary selection of effective obstacle grid cells in operation S3. Therefore, it allows for a faster and more accurate identification of effective obstacle grid cells that represent the obstacle contour, enabling the robot to more smoothly approach the obstacle and walk steadily along its contour.

In this embodiment, the distance between the start point of each line segment and the robot body's center along the predefined detection direction is less than the robot body's radius. This means that the distance, between the left endpoint of the arrowed line segment passing through obstacle L1 in FIG. 3 (excluding the Xr axis) and the robot body's center R1 in the positive direction of the Xr axis, is less than the robot body's radius. Among the line segments set in operation S2, the maximum distance between the left endpoint of a line segment and the right side edge of the robot in the positive direction of the Xr axis is preferably 20 mm; this ensures that the line segments set in operation S2 cover a small portion of the robot body on the side near the obstacle.

It should be noted that the side of the robot near the obstacle refers to the side of the robot body that is closest to the obstacle during its movement along the edge of the obstacle where the obstacle contour point is located. Correspondingly, in FIG. 3, the obstacle that the robot follows is obstacle L1 in FIG. 3. The left endpoint of a line segment set in operation S2 is the extension start point of the line segment, while the right endpoint of the same line segment is the extension end point. This assigns directional information to the line segment set in operation S2. Based on this, the line segment set in operation S2 is equivalent to a vector line segment set within the grid map.

In operation S2, the distance between the extension end point of each line segment and the robot body's center in the preset detection direction is greater than the robot body's radius. This ensures that the line segments extend outward from the robot body, so that the line segment can pass through the grid cell occupied by the obstacle contour point. The robot body's radius represents half of the robot body's width. The distance between the extension start point of each line segment and the edge of the robot closer to the obstacle is smaller than the distance between the extension end point of the same line segment and the edge of the robot closer to the obstacle. That is, the distance from the extension start point of each line segment to the position point of the edge of the robot body passed through by the line segment is smaller than the distance from the extension end point of the same line segment to the position point of the edge of the robot body passed through by the line segment. This ensures that the coverage area of the line segment set in operation S2 outside the robot body is larger than the coverage area of the line segment inside the body.

Referring to FIG. 3, in operation S2, the minimum distance between the right endpoint of the line segment and the robot's right side edge in the positive direction of the Xr axis is preferably 150 mm. This ensures that the line segment set in operation S2 reserves a movable area between the robot body and its adjacent obstacle. Additionally, for the same line segment, the distance between the extension start point (left endpoint) and the robot's edge closer to the obstacle (the position point of the right-side edge passed by the same line segment) is smaller than the distance between the extension end point (right endpoint) and the robot's edge closer to the obstacle (the position point of the right-side edge passed by the same line segment).

Therefore, operation S2 provides specific direction and clearance information for the obstacle contours that the robot is detecting. Since the set line segments pass through both the robot's edge and the contour of the obstacle it follows, each line segment within the map area defined by the multiple line segments can systematically acquire the grid cell of each obstacle contour point along the preset detection direction. This setup also accommodates the robot's pose adjustment within the area between the robot's edge and the obstacle contour, based on the difference in rotation speeds between the left and right wheels.

As an embodiment, among the multiple parallel line segments set by the robot, the perpendicular distance from the robot body's center to the farthest line segment from the robot body's center is equal to the robot body's radius. The perpendicular distance from the robot body's center to the nearest line segment from the robot body's center is equal to zero. In operation S2, among the line segments shown (except for the Xr axis), the topmost line segment passing through the obstacle L1 is the farthest from the robot body's center R1, and the perpendicular distance from the robot body's center R1 to this line segment is equal to the robot body's radius, i.e., the radius of the circle centered at point R1. The bottom most line segment passing through obstacle L1 is positioned on the Xr axis and is the closest to the robot body's center R1, with the perpendicular distance from the robot body's center R1 to this line segment equal to zero. Among the multiple parallel line segments set, the robot configures the distance between two adjacent line segments to be equal to the resolution of a single grid cell. Preferably, the length of each line segment is the same, and the resolution of a single grid cell is 10 mm. Thus, the adjacent line segments can be viewed as defining a regular region composed of multiple cells arranged along the preset detection direction. Since the preset detection direction is perpendicular to the target planning direction, operation S2 is equivalent to setting multiple evenly spaced line segments starting from the robot body's center along the target planning direction. Each line segment can be viewed as extending along the preset detection direction to pass through obstacle grid cells, representing a rectangular grid area with evenly spaced line segments. These line segments are sequentially distributed in the grid map according to the grid resolution. While acquiring the grid cells containing the obstacle contour points along the line segments, the influence of offset errors caused by the grid resolution is also taken into account.

As an embodiment, after the robot collects the obstacle contour points in operation S1, it sets the position coordinates of the obstacle contour points as local coordinates formed relative to the robot's current position. In this context, the local coordinates are within the robot's coordinate system, with the robot's current position being the origin of the robot's coordinate system, and the robot's current position is represented by the robot body's center. The local coordinates of the obstacle contour point correspond to the coordinates of the obstacle contour point within the robot's coordinate system.

To obtain the grid cell containing the obstacle contour point, the robot converts the local coordinates to the global map coordinate system used for constructing the grid map. Specifically, the local coordinates of the obstacle contour point are transformed into the global map coordinate system through rotation and translation transformations, yielding the grid coordinates of the obstacle contour point. These coordinates are represented by the filled black unit cells in FIGS. 3 to 4, distributed along the contour of obstacle L1. At this point, the robot determines the grid cell where the obstacle contour point is located within the grid map by performing operation S1, and completes the identification of the obstacle contour point in the corresponding grid cell of the grid map. Generally, a collected obstacle contour point (which can be understood as a laser point) hits at least one grid cell in the grid map or neighboring grid cells centered around one grid cell, thereby obtaining multiple grid coordinates for a single obstacle contour point.

It should be noted that the rotation angle required for performing a rotational transformation of the local coordinates is equal to the angle between the coordinate axes of the same orientation (i.e., corresponding coordinate axes with the same attribute) in the global map coordinate system and the robot coordinate system. The coordinate translation amount required for performing a translational transformation of the local coordinates is equal to the coordinate values of the robot's current position in the global map coordinate system. This amount also represents the translation offset between the origin of the global map coordinate system and the origin of the robot coordinate system. Specifically, the translation displacement required for transforming the local coordinates along the horizontal axis of the robot coordinate system is equal to the abscissa value of the robot's current position in the global map coordinate system; likewise, the translation displacement required for transforming the local coordinates along the vertical axis of the robot coordinate system is equal to the ordinate value of the robot's current position in the global map coordinate system. The coordinate values of the robot's current position in the global map coordinate system include both the abscissa value and the ordinate value of the robot's current position in the global map coordinate system.

Based on the trigonometric transformation relationships known to those skilled in the art, a coordinate system transformation equation can be constructed using the rotation angle required for the rotational transformation of the local coordinates and the coordinate translation amount required for the translational transformation of the local coordinates. By substituting the position coordinates of the obstacle contour points into the coordinate system transformation equation, the grid coordinates of the obstacle contour points can be obtained, thereby enabling the marking of the obstacle contour points in the corresponding grid cells of the grid map.

Specifically, the coordinate system transformation equation is as follows:

xₘ=xₚ cos θ−yₚ sin θ+x₀;

yₘ=xₚ sin θ+yₚ cos θ+y₀;

Wherein, the position coordinates of the obstacle contour point (in the robot coordinate system) are (xₚ, yₚ), the coordinates of the current position of the robot in the global map coordinate system are (x₀, y₀); the rotation angle required for the rotational transformation of the local coordinates is 0, which serves as the rotation angle for the coordinate transformation of the obstacle contour point; and the grid coordinates of the obstacle contour point are (xₘ, yₘ). The horizontal axis of the global map coordinate system is denoted as the Xs axis, and the vertical axis of the global map coordinate system is denoted as the Ys axis.

Preferably, the preset detection direction is parallel to the axle of the robot, and the line segments set in operation S2 are parallel to the preset detection direction. The positive direction of the vertical axis of the robot coordinate system is aligned with the target planning direction, and the positive direction of the horizontal axis of the robot coordinate system is aligned with the preset detection direction. As shown in FIG. 3, the preset detection direction corresponds to the positive direction of the Xr axis (the positive direction of the horizontal axis of the robot coordinate system). The preset detection direction is parallel to the axle of the robot, and the line segments set in operation S2 are parallel to the preset detection direction, i.e., the arrowed line segments passing through the obstacle L1 (excluding the Xr axis itself) are parallel to the Xr axis in FIG. 3. As a result, a line segment scanning region parallel to the axle of the robot is formed in the grid map. Additionally, the target planning direction corresponds to the positive direction of the Yr axis (the positive direction of the vertical axis of the robot coordinate system). When the line segments set in operation S2 are parallel to the horizontal axis of the robot coordinate system, a standard scanning direction is provided for the grid cells containing the obstacle contour points traversed by the line segments. When obtaining the grid coordinates, the direction of the coordinate axes can be used as a reference angle, thereby reducing the computational complexity of angular rotation.

As an embodiment, the robot may adopt a circular-shaped body, for example, a vacuum cleaner. The robot includes a semi-circular front portion (head), a semi-circular rear portion (main body), and two symmetrically arranged wheels. The two symmetrically arranged wheels are connected by an axle, which is disposed at the boundary between the head and the main body. As illustrated by the Xr axis in FIGS. 2 to 4, the center of the axle corresponds to the position point R1. The semi-circular head and semi-circular main body together form a circular-shaped robot body. The diameter of the robot body is equal to the width of the robot body. The longest distance from the center point R1 of the robot body to its edge represents the radius of the robot body, which is equal to half of the width of the main body or half of the width of the head. The center of the axle also serves as the center of the robot body. The target planning direction is orthogonal to the axle and corresponds to the positive direction of the Yr axis as shown in FIGS. 2 to 4 (i.e., the direction indicated by the arrow on the Yr axis). Accordingly, the robot coordinate system can be constructed based on the physical dimensions of the robot body and the internal axle configuration. Furthermore, multiple parallel line segments may be set for selecting the grid cells containing the obstacle contour points, thereby providing an appropriate direction for subsequent curve fitting operations.

The preset detection direction is defined as the direction parallel to the wheel axle and oriented toward the obstacle on the side of the robot. The obstacle on the side of the robot (side obstacle) refers to an obstacle located outside the lateral side of the robot body, and multiple parallel line segments set in operation S2 pass through the grid cells occupied by the side obstacle in the grid map. The side obstacle is located outside the lateral side of the robot body, where the lateral side refers to either the left or right side of the robot body. Therefore, the side obstacle refers to an obstacle located on the left or right side of the robot without being in contact with the robot. Preferably, the traveling direction of the robot is defined as the direction pointing toward the front of the robot, and this traveling direction is parallel to the target planning direction, which is orthogonal to the wheel axle.

As an embodiment, in operation S3, the method for selecting effective obstacle grid cells from among the grid cells of the obstacle contour points traversed by each line segment, based on the occupancy probability values corresponding to the grid cells of the obstacle contour points, includes: for each line segment, selecting the grid cell with the highest occupancy probability value from among the grid cells of the obstacle contour points traversed by that line segment. Preferably, the grid cells of the obstacle contour points are sequentially traversed along the preset detection direction, and through comparison, after traversing all the grid cells of the obstacle contour points along the same line segment, the grid cell with the highest occupancy probability value is identified. After obtaining the grid cell with the highest occupancy probability value along each line segment in a single execution of operation S3, the robot marks the grid cell with the highest occupancy probability as the effective obstacle grid cell corresponding to that line segment. This enables an accurate positioning result, at the current time, for one of the contour points of the obstacle that is intersected by the line segment.

In some embodiments, the grid cell having the highest occupancy probability value along the same line segment or the preset detection direction may alternatively be selected by first identifying a grid cell whose occupancy probability value exceeds a predefined occupancy probability threshold. The first grid cell, along the line segment, whose occupancy probability exceeds the predefined threshold is regarded as the grid cell with the highest occupancy probability value, and is marked as the effective obstacle grid cell corresponding to that line segment.

As shown in FIGS. 3 and 4, the arrowed line segments passing through the obstacle L1 mostly traverse two unit cells filled in black, i.e., two grid cells where obstacle contour points are located. In this case, the grid cell with the highest occupancy probability value among the grid cells traversed by the same line segment is extracted as the effective obstacle grid cell for that line segment (not explicitly shown in the figures). The coordinates of the effective obstacle grid cell represent the grid coordinates of the obstacle in the grid map, which also are the grid coordinates in the global map coordinate system. Subsequently, the effective obstacle grid cells corresponding to all the configured line segments are combined to form the effective contour of the obstacle in the grid map. Specifically, in the same execution of operation S3, the robot sequentially connects the effective obstacle grid cells corresponding to the newly set line segments from the most recent execution of operation S2, thereby forming the effective contour of the obstacle in the grid map. This is equivalent to an obstacle contour line formed by connecting the effective obstacle grid cells at equal intervals along the target planning direction. This approach utilizes the occupancy probability information to reduce the amount of marking required and also overcomes errors caused by a single obstacle contour point being simultaneously marked or hit in multiple grid cells. By navigating along the contour area composed of the effective obstacle grid cells, the robot ensures stable edge-following movement. When the effective obstacle grid cells represent a wall contour, the effective grid cells may lie on the same straight line, thus further ensuring the robot's stability in wall-following navigation.

Specifically, the laser sensor is mounted on the robot body, with the center of the laser sensor disposed at position point R2 in FIG. 2. Preferably, the center of the robot body is disposed at position point R1 in FIG. 2. The laser probe is rotatably installed inside the laser sensor, allowing the robot to acquire contour points of obstacles. It should be noted that the laser probe of the laser sensor rotates at a constant speed to detect the surrounding environment. The laser sensor emits laser beams to scan, at varying angles, part or all of the region covered by the multiple line segments configured in operation S2. Each scanning angle corresponds to one laser point. The collection of all laser points generated during a full 360-degree rotation forms a single frame of point cloud data.

Among the detected obstacle contours, each scanning angle corresponds to one obstacle contour point. The obstacle contour points acquired by the robot are point cloud, which are formed by laser beams emitted from the laser probe and reflected from the obstacle contours when the laser probe rotates at least one full circle. These reflections form the point cloud, within which laser points reflected from the surface of obstacles are regarded as obstacle contour points in this embodiment. Once an obstacle contour point hits at least one grid cell in the grid map, the hit grid cell is marked as a grid cell containing an obstacle contour point. Such a grid cell is assigned a hit probability value. The hit probability value at the initial hit is an initial occupancy probability value. In this embodiment, the initial hit probability value for each grid cell at the current moment can be determined using existing methods known in the related art, which will not be further detailed here.

It should be noted that the grid map includes probabilistic information indicating the presence of obstacles at specific locations or areas. For example, the object to be detected is scanned using the robot's laser sensor to acquire the corresponding position information of the object. Based on this, the probability information of the object falling into/hitting the corresponding grid location on the map can be calculated and used as the hit probability value for the corresponding grid cell. This hit probability value can be used to represent the likelihood that the grid cell containing the obstacle contour point is occupied by the obstacle.

In certain implementation scenarios, the robot may detect a fixed obstacle (the object to be detected) at different detection distances at different times under the same pose. For example, the detection distance of a laser sensor in one frame of point cloud data at a certain time could be 5 m, while in another frame collected at a different time, the detection distance could be 5.1 m, resulting in obstacle contour points at different positions. To avoid marking the obstacle contour points at 5 m and 5.1 m as the same contour point, an occupancy grid map construction algorithm is employed to calculate the probability information of the fixed obstacle falling into (or hitting) the corresponding grid location on the map. Based on the probability values, the precise position of the fixed obstacle in the map can then be determined.

As an embodiment, whenever an obstacle contour point hits the corresponding grid cell, the hit probability value previously assigned to the corresponding grid cell is accumulated to obtain the occupancy probability value for that grid cell. This can involve accumulating the hit probability values of the same grid cell from the previous moment to obtain the occupancy probability value, so that the occupancy probability value of the same grid cell is updated as the number of hits on the obstacle contour points changes. The accumulated hit probability value is updated to the occupancy probability value, so that the hit probability value assigned to the grid cell where the obstacle contour point is located is updated to the occupancy probability value. If multiple obstacle contour points hit the same grid cell during one full rotation of the laser probe, the hit probability values respectively corresponding to the hits on that grid cell are accumulated sequentially. If necessary, after each accumulation, the accumulated result is updated to the occupancy probability value, ultimately obtaining the latest occupancy probability value for that grid cell after this full rotation of the laser probe. If only one obstacle contour point hits the same grid cell during one full rotation of the laser probe, the hit probability value corresponding to that grid cell is directly updated to the occupancy probability value, representing the occupancy probability value of the hit grid cell during the laser probe's full rotation. If multiple obstacle contour points hit the same grid cell during at least two rotations of the laser probe (not limited to a single rotation or multiple rotations), the respective hit probability value for each hit on that grid cell is accumulated sequentially. If necessary, after each accumulation, the accumulated result is updated to the occupancy probability value, ultimately obtaining the latest occupancy probability value for that grid cell after at least two rotations of the laser probe. When one obstacle contour point hits one grid cell, and the hit probability value corresponding to that grid cell is accumulated once, causing the occupancy probability value of that grid cell to be updated once, this counts as one hit; therefore, the occupancy probability value of the same grid cell is updated as the number of hits on the obstacle contour point changes, overcoming the issue of the same obstacle contour point being simultaneously marked/hit to multiple grid cells, and improving the accuracy of grid cell marking for obstacle contour.

Preferably, at the robot's current position, the more times the robot controls the laser probe to rotate, the more obstacle contour points hit the same grid cell. This increases the occupancy probability value of the same grid cell being hit, so that the occupancy probability value of the same grid cell is updated as the number of rotations of the laser probe increases. Under the condition that the laser sensor is rotating and scanning the environment, the surrounding environment can be updated in real time, allowing the occupancy probability value of the grid cell to more accurately reflect the status of surrounding obstacles.

Generally, since the obstacle contour points are represented by a grid map during the laser sensor's scanning of obstacles, and the robot directly uses the grid map to avoid obstacles, this can lead to grid resolution errors (determined by the grid map's resolution, where the grid resolution is 10 mm, resulting in a 10 mm positioning coordinate error when the grid map is used directly for obstacle-avoidance) and laser data jitter (for example, the same contour point of a wall may be marked by multiple grid cells in the grid map). This causes continuous jitter in the movement of differential drive robots like vacuum cleaners. Therefore, fitting can be performed (which is equivalent to smoothing the effective obstacle grid cells selected in operation S3; the smoothness of the fitted curve is smaller than the grid resolution) to eliminate errors and compensate for the sampling points lost due to grid resolution. Specifically, the grid coordinates of the effective obstacle grid cells from operation S3 are first converted back to the robot's coordinate system, and then curve fitting is performed in a coordinate system with the robot body's center as the origin.

Therefore, before performing the curve fitting operation in operation S4, the robot first converts the grid coordinates of the effective obstacle grid cells selected in operation S3 from the global map coordinate system back to the robot coordinate system, in order to obtain the position coordinates of the effective contour points. It should be noted that, between the global map coordinate system and the robot coordinate system, the rotation transformation of the grid coordinates of the effective obstacle grid cells is the inverse transformation of the rotation transformation applied to the local coordinates, and the translation transformation of the grid coordinates of the effective obstacle grid cells is the inverse transformation of the translation transformation applied to the local coordinates.

Between the global map coordinate system and the robot coordinate system, the rotation transformation of the grid coordinates of the effective obstacle grid cells is the inverse transformation of the rotation transformation of the local coordinates, and the translation transformation of the grid coordinates of the effective obstacle grid cells is the inverse transformation of the translation transformation of the local coordinates. Specifically, the inverse transformation equations of the coordinate systems are as follows:

xₚ=(xₘ−x₀)cos θ+(yₘ−y₀)sin θ;

yₚ=(yₘ−y₀)cos θ−(xₘ−x₀)sin θ;

Among them, the position coordinates of the effective contour point (in the robot coordinate system) are (xₚ, yₚ), the current position of the robot in the global map coordinate system is (x₀, y₀); the rotation angle required for the rotational transformation of the grid coordinates of the effective obstacle grid cell is 0, which is the angle by which the obstacle contour point needs to be rotated during the coordinate transformation; and the grid coordinates of the effective obstacle grid cell are (xₘ, yₘ), which correspond to the grid cell where the obstacle contour point is located.

As an embodiment, before performing the curve fitting operation in operation S4, if the position coordinates of the effective contour point are obtained, the robot controls the effective contour point to be translated in the direction opposite to the preset detection direction by a preset obstacle-avoidance margin, so as to obtain a fitting target point. This is regarded as the completion of the coordinate transformation of the effective obstacle grid cell and the translation operation in the opposite direction of the preset detection direction. Wherein, the preset obstacle-avoidance margin is defined as the sum of the robot body's radius and a preset obstacle-avoidance distance. The effective contour point refers to a representative obstacle contour point, located in the robot coordinate system, obtained after performing coordinate transformation on the effective obstacle grid cell; it already eliminates the influence caused by laser data jitter but still requires addressing the localization error introduced by grid resolution. The effective contour point is located, relative to the robot, on the side of the center of the robot body in the preset detection direction. The preset obstacle-avoidance distance is preferably 15 mm. The direction opposite to the preset detection direction is defined as the target translation direction. By translating each effective contour point along the target translation direction by the preset obstacle-avoidance margin, discrete points that can simulate the obstacle contour are obtained—namely, the aforementioned fitting target points. Thereby, the discrete points that simulate the obstacle contour are brought closer to the robot, allowing the robot to travel in close proximity along the curve trajectory fitted to the fitting target points, while maintaining a certain distance from the obstacle located on the side of the preset detection direction.

As an embodiment of operation S4, in the case where the curve fitting operation is Bezier curve fitting, the start point and the end point of the Bezier curve are determined from the fitting target points along the target planning direction. The Bezier curve to be fitted extends from the start point of the Bezier curve to the end point of the Bezier curve. Referring to FIG. 4, the start point of the Bezier curve is point A, the end point is point B, and the target planning direction corresponds to the positive direction of the illustrated coordinate Yr axis.

Among the translated fitting target points, the fitting target points distributed along the target planning direction are sequentially marked as control points for fitting the Bezier curve. The fitting target points distributed along the target planning direction between the start point and the end point of the Bezier curve are sequentially marked as intermediate points for the Bezier curve fitting. The number of control points is equal to the order of the Bezier curve plus one, and also equal to the total number of the Bezier curve's start point, end point, and intermediate points. The order of the Bezier curve is denoted as n. The end point of the Bezier curve corresponds to the preset obstacle-avoidance end point disclosed in operation S6.

According to the start point, end point, and intermediate points of the Bezier curve, a fitted curve equation for obstacle-avoidance is generated. Specifically, on the robot coordinate plane, a fitted curve for obstacle-avoidance based on an n-th order Bezier curve is generated. Correspondingly, a fitted curve equation for obstacle-avoidance is generated based on the n-th order Bezier curve, namely, the n-th order Bezier curve equation is generated. This allows the relatively discrete fitting target points to be connected into a relatively continuous contour line formed by consecutive points, thereby achieving a smoothing process for the effective contour points or effective obstacle grid cells, and overcoming the grid error that would otherwise result from directly avoiding obstacles based on a grid map.

Specifically, the fitted curve equation for obstacle-avoidance is:

$$\{ \begin{matrix}{B}_{x} ( t ) = {\sum }_{i = 0}^{n} ( \begin{matrix}n \\ i\end{matrix} ) {{P}_{i x} ( 1 - t )}^{n - i} {t}^{i} , t ∈ [ 0 , 1 ] \\ {B}_{y} ( t ) = {\sum }_{i = 0}^{n} ( \begin{matrix}n \\ i\end{matrix} ) {{P}_{i y} ( 1 - t )}^{n - i} {t}^{i} , t ∈ [ 0 , 1 ]\end{matrix} ;$$

The fitted curve equation for obstacle-avoidance represents the trajectory equation corresponding to a fitted curve for obstacle-avoidance. Let Bₓ(t) denote the abscissa of a point on the fitted curve for obstacle-avoidance, and B_{y}(t) denote the ordinate of the point on the fitted curve for obstacle-avoidance. The variable i represents the index number of a control point required for constructing the fitted curve for obstacle-avoidance. The difference between the ordinate of the control point at index i and that at index (i+1) can be fixed. The variable t is defined as the ratio of i to (n+1), and is used to represent the proportion of the index of the latest fitted point along the target planning direction relative to the total number of points to be fitted during a single execution of operation S4. The index i denotes the ordering of the control points required for the fitted curve for obstacle-avoidance along the target planning direction, which is considered as the positive direction of the coordinate Yr axis shown in FIG. 4, and is configured to increment from the value 0 along the target planning direction.

The start point, end point, and intermediate points of the Bézier curve all belong to the control points required for Bézier curve fitting. The start point of the Bézier curve serves as the start point of the fitted curve for obstacle-avoidance, and the end point of the Bézier curve serves as the end point of the fitted curve for obstacle-avoidance. Let Pᵢₓ denote the abscissa of the fitting target point used as a control point Pᵢ, and P_{iy} denote the ordinate of the fitting target point used as the control point Pᵢ. Let P₀ₓ denote the abscissa of the Bézier curve's start point, and P_{0y} denote its ordinate. Let Pₙₓ denote the abscissa of the Bézier curve's end point, and P_{ny} denote its ordinate. The notation

$$( \begin{matrix}n \\ i\end{matrix} )$$

represents the binomial coefficient of (Pᵢₓ, P_{iy}) at a specific value of t, similar to the binomial coefficient in the binomial expansion, and follows the distribution pattern of Pascal's Triangle.

It should be noted that the fitted curve equation for obstacle-avoidance belongs to the class of Bézier curve formulas. A Bézier curve is a mathematical curve used in two-dimensional graphic applications. The curve is defined by a start point (also referred to as the initial point), an end point (also referred to as the terminal point), and one or more control points. By adjusting the control points, the shape of the Bézier curve can be altered accordingly.

In the process of Bézier curve fitting, the number of different values of t is equal to the number of interpolated points in the Bézier curve to be fitted. This enables interpolation of discrete points into a visually continuous set of points. When the relative positions of two adjacent control points along the target planning direction change, the curvature (i.e., the degree of bending) of the Bézier curve changes accordingly. The two adjacent control points are represented as Pᵢ and Pᵢ₊₁, where i∈[0, n−1]. The start point of the Bézier curve is represented as P₀, and the end point is represented as Pₙ. During the Bézier curve fitting process, the index i increases progressively from the start point until it reaches the end point, at which point t equals 1. As a result, relatively discrete target fitting points can be smoothly connected into a relatively continuous contour line. Compared with the error present in grid-marked contour points, Bézier curve fitting can use interpolated fitted points to compensate for contour points lost during data acquisition, and fit a curve that more closely follows the actual contour of the obstacle. This achieves a smoothing process of the obstacle contour points located in grid cells using a Bézier curve.

As is well known to those skilled in the art, when the start point and end point of a Bézier curve are fixed, moving the intermediate point on the line segment connecting two adjacent control points will change the value of t. It should be noted that a Bézier curve does not necessarily pass through all the intermediate control points; however, it is guaranteed to pass through the start point and the end point.

As an embodiment, the method for determining the start point and end point of the Bézier curve from the fitting target points includes: The start point of the Bézier curve is the fitting target point—among all fitting target points obtained by performing coordinate system transformation and translation on the effective obstacle grid cells selected in the same operation S3—that has the smallest coordinate value along the target planning direction. This point represents the fitting target point closest to the center of the robot body and corresponds to point A in FIG. 4, which lies at the minimum coordinate value along the Yr axis and serves as the navigation point nearest to the robot. The end point of the Bézier curve is the fitting target point—among all fitting target points obtained by performing coordinate system transformation and translation on the effective obstacle grid cells selected in the same operation S3—that has the largest coordinate value along the target planning direction. This point represents the fitting target point farthest from the center of the robot body and corresponds to point B in FIG. 4, which lies at the maximum coordinate value along the Yr axis and serves as the farthest navigation point obtained in the current curve fitting operation. Accordingly, by subsequently controlling the robot to navigate in the direction from the Bézier curve's start point to its end point, the robot can bypass the obstacle formed by all effective obstacle grid cells selected in the same operation S3, or follow the contour formed by these effective obstacle grid cells without colliding with the corresponding obstacle.

As an embodiment, in operation S5, the method by which the robot derives an obstacle-avoidance target point from the fitted curve equation for obstacle-avoidance based on the adjacent position point of the current position in the target planning direction includes: The robot calculates the coordinate value of the adjacent position point of the current position in the target planning direction. If the target planning direction is configured as the positive direction of the vertical axis in the robot's coordinate system, then the coordinate value of the adjacent position point in the target planning direction refers to the adjacent ordinate value of the current position. The difference between the ordinate of each position point and its adjacent ordinate is a fixed coordinate value. This adjacent ordinate value is set as the look-ahead ordinate value. Then, the robot substitutes the look-ahead ordinate value into the fitted curve equation for obstacle-avoidance, and calculates the abscissa value of the point on the curve whose ordinate matches the look-ahead ordinate value. The robot thereby obtains the position coordinate (including the abscissa and ordinate) of the point on the fitted curve for obstacle-avoidance where the ordinate equals the look-ahead ordinate value, and marks this point as the obstacle-avoidance target point. In this way, one obstacle-avoidance target point is derived from the fitted curve equation for obstacle-avoidance. By continuously performing such calculations for successive position points in the determined direction, the system effectively reduces the computational cost of curve fitting and improves the efficiency of obstacle-avoidance navigation for the robot.

Based on the previous embodiments, in operation S6, the method by which the robot repeatedly executes operations S5 to S6, and each time it reaches an obstacle-avoidance target point, until it reaches a preset obstacle-avoidance end point, includes: Every time the robot reaches an obstacle-avoidance target point, the robot enters the fitted curve for obstacle-avoidance. The robot updates the current obstacle-avoidance target point to its current position and then executes operation S5 to obtain the next obstacle-avoidance target point. The robot then moves to the next obstacle-avoidance target point. After reaching the next target point, the robot updates this target point to its current position and repeats operations S5 to S6. This process continues, and as shown in FIG. 4, the robot moves in the positive direction of the Yr axis sequentially through each of the black discrete circular points between Point A (the first computed obstacle-avoidance target point) and Point B (the thirteenth computed obstacle-avoidance target point, which is the preset obstacle-avoidance end point) until the robot reaches the preset obstacle-avoidance end point. Therefore, the robot follows the fitted curve for obstacle-avoidance, maintaining a certain distance from the obstacle contour represented by all the effective obstacle grid cells selected in the same operation S3. This process enables the robot to continuously walk along the side of the obstacle, relying on the fitted curve to track the obstacle's contour without collision.

In the process of repeatedly executing operations S5 to S6, when the robot continuously updates the already computed obstacle-avoidance target points to its current position, it will continue to compute new obstacle-avoidance target points along the target planning direction. As shown in FIG. 4, the obstacle-avoidance target points can be Point A, Point B, and various black discrete circular points arranged along the positive direction of the Yr axis between Point A and Point B. If these points (Point A, the black discrete circular points, and Point B) are connected sequentially, they form the obstacle-avoidance trajectory, by which the robot walks along the right-side contour of obstacle L1. This trajectory can be considered as the fitted curve for obstacle-avoidance extending along the target planning direction, starting from the robot body's center R1 and extending upwards. Compared to the motion trajectory formed by grid stitching in existing technologies, the fitted curve for obstacle-avoidance calculated by connecting the obstacle-avoidance target points in this embodiment can improve the accuracy and smoothness of the obstacle-avoidance trajectory.

Preferably, the difference between the coordinates of an adjacent position point in the target planning direction and the coordinate value of the current position in the target planning direction is equal to a preset parameter, such that the coordinate values of the obstacle-avoidance target points obtained sequentially in operation S6 change unidirectionally along the extension direction of the fitted curve for obstacle-avoidance. For example, when the preset parameter is 1, the unidirectional change is an increasing change; and when the preset parameter is −1, the unidirectional change is a decreasing change.

The iterative actions of repeatedly executing operation S5 and operation S6 mentioned in the foregoing embodiments involve calculating the coordinates of each obstacle-avoidance target point sequentially along the extension direction of the fitted curve for obstacle-avoidance or the target planning direction. Moreover, the coordinate difference in the target planning direction between two adjacent obstacle-avoidance target points involved in the calculation is fixed. In this case, the coordinate value of the obstacle-avoidance target point in the target planning direction is preferably the ordinate value in the robot's coordinate system. Based on the rule of unidirectional change of coordinates along the extension direction of the fitted curve for obstacle-avoidance, the robot continuously calculates the next obstacle-avoidance target point ahead of the robot until it reaches the end point of the fitted curve for obstacle-avoidance (i.e., the preset obstacle-avoidance end point).

In some embodiments, the coordinate values of the successive obstacle-avoidance target points in the target planning direction change unidirectionally along the extension direction of the fitted curve for obstacle-avoidance. Specifically, this is manifested as follows: starting from the first calculated look-ahead ordinate value, the ordinate of the current obstacle-avoidance target point relative to the ordinate of the previously determined obstacle-avoidance target point generates a coordinate shift of a value equal to 1. Here, the current obstacle-avoidance target point is the adjacent position point in the target planning direction to the previously determined obstacle-avoidance target point. Therefore, the extension direction of the fitted curve for obstacle-avoidance is the direction in which the ordinates of the obstacle-avoidance target points obtained sequentially in the process of repeatedly executing operation S5 and operation S6 increase.

The ordinate of the obstacle-avoidance target point calculated during the first execution of operation S5 is in the same coordinate system as the ordinate of the robot's current position at the stage of executing operation S4. The coordinate shift generated in the target planning direction is equal to a value of 1. The obstacle-avoidance target point calculated during the first execution of operation S5 is the adjacent position point in the target planning direction to the robot's current position at the stage of executing operation S4.

In the embodiments provided in this disclosure, it should be understood that the disclosed systems, devices, and methods can be implemented in various ways. For example, the device embodiments described above are merely illustrative. The division of units is just one logical functional division, and during actual implementation, there can be other division methods. For instance, multiple units or components can be combined or integrated into another system, or some features may be omitted or not executed. Additionally, the coupling or communication between the displayed or discussed components may be achieved through interfaces or through indirect coupling or communication connections between devices or units, which could be electrical, mechanical, or in other forms. The units described as separate components may or may not be physically separate. The components displayed as units may or may not be physical units; they may be located in one place or distributed across multiple network units. Depending on actual needs, some or all of the units may be selected to achieve the objectives of the present embodiment.

A person skilled in the art will understand that the full or partial processes of the methods in the above embodiments can be implemented by a computer program to instruct the relevant hardware to perform the tasks. This computer program can be stored on a non-volatile computer-readable storage medium. When executed, the program may include the processes described in the embodiments above. In the various embodiments provided in this disclosure, references to memory, storage, databases, or other media may include a non-volatile and/or volatile memory. The non-volatile memory may include a read-only memory (ROM), programmable read-only memory (PROM), electrically programmable read-only memory (EPROM), electrically erasable programmable read-only memory (EEPROM), or flash memory. The volatile memory may include a random access memory (RAM) or external cache memory.

The technical features of the above embodiments can be combined in any manner. For the sake of brevity, not all possible combinations of the features in the embodiments are described. However, as long as these combinations of technical features do not conflict with each other, they should be considered within the scope of this specification.

The above embodiments represent several implementations of the present disclosure, described in a specific and detailed manner, but should not be construed as limiting the scope of the disclosure. It should be noted that, for a person skilled in the art, several modifications and improvements can be made without departing from the spirit of the present disclosure, and these are all within the scope of protection of this disclosure.

1. A robot obstacle-avoidance control method, performed by a robot, based on map probability information, the method comprising:
controlling a laser sensor of the robot to perform rotational scanning, collecting one or more obstacle contour points of an obstacle, and obtaining, from a grid map, one or more grid cells in which the one or more obstacle contour points are located and one or more occupancy probability values respectively corresponding to the one or more grid cells;
establishing a plurality of line segments on a side of the robot proximate to the obstacle such that each line segment traverses one or more grid cells, containing one or more corresponding obstacle contour points of the obstacle contour points, of the grid cells;
for each line segment, selecting, from among the one or more grid cells traversed by the line segment that contain the one or more corresponding obstacle contour points, an effective obstacle grid cell based on one or more occupancy probability values corresponding to the one or more grid cells traversed by the line segment;
performing a curve fitting operation using the effective obstacle grid cell to generate a fitted curve equation for obstacle-avoidance;
calculating an obstacle-avoidance target point from the fitted curve equation for obstacle-avoidance based on a position point adjacent to a current position of the robot along a target planning direction, to cause the robot to travel from its current position to the obstacle-avoidance target point; and
updating the current position of the robot to be the obstacle-avoidance target point each time the robot reaches the obstacle-avoidance target point, and repeating the operations of calculating the obstacle-avoidance target point and updating the current position of the robot until the robot reaches a predetermined obstacle-avoidance end point.

2. The robot obstacle-avoidance control method according to claim 1, further comprising:
updating the current position of the robot to be the predetermined obstacle-avoidance end point each time the robot reaches the predetermined obstacle-avoidance end point, and repeating the operations of performing rotational scanning, collecting the one or more obstacle contour points, obtaining the one or more grid cells, establishing the plurality of line segments, selecting the effective obstacle grid cell, performing the curve fitting operation, calculating the obstacle-avoidance target point, and updating the current position of the robot, until the robot reaches a target navigation end point, at which point execution of the robot obstacle-avoidance control method terminates;
wherein the predetermined obstacle-avoidance end point is a fitted end point for generating the fitted curve equation for obstacle-avoidance, and corresponds to the fitted curve equation for obstacle-avoidance generated from the curve fitting operation.

3. The robot obstacle-avoidance control method according to claim 1, wherein the plurality of line segments on the side of the robot proximate to the obstacle are parallel and disposed along the target planning direction, and each line segment is configured to extend toward the grid cell in which the obstacle contour point is located;
wherein a start point of extension of each line segment is at a distance from a center of a robot body of the robot in a preset detection direction that is less than a radius of the robot body, and an end point of extension of the line segment is at a distance from the center of the robot body in the preset detection direction that is greater than the radius of the robot body;
wherein a distance from the start point of extension of each line segment to an edge of a side of the robot closer to the obstacle is less than a distance from the end point of extension of the line segment to the edge of the side of the robot closer to the obstacle;
wherein the side of the robot closer to the obstacle refers to, during a process in which the robot moves along an edge of the obstacle where the one or more obstacle contour points are located, a side of the robot body that is nearest to the obstacle where the one or more obstacle contour points are located; and
wherein the preset detection direction is perpendicular to the target planning direction; and the radius of the robot body refers to half of a width of the robot body.

4. The robot obstacle-avoidance control method according to claim 3, wherein among the plurality of line segments that are parallel, a distance from the center of the robot body to a line segment farthest from the center of the robot body along the target planning direction is equal to the radius of the robot body, and a distance from the center of the robot body to a line segment nearest to the center of the robot body along the target planning direction is equal to zero; and
among the plurality of line segments that are parallel, a spacing between each pair of adjacent line segments is configured by the robot to be equal to a resolution of a single grid cell in the grid map.

5. The robot obstacle-avoidance control method according to claim 3, wherein after the collecting of the one or more obstacle contour points, the robot configures position coordinates of the obstacle contour points as local coordinates of the obstacle contour points relative to the current position of the robot; wherein the local coordinates are located in a robot coordinate system, and the current position of the robot is an origin of the robot coordinate system and represented by the center of the robot body;
wherein when the robot converts the local coordinates to a global map coordinate system which is for constructing the grid map, the local coordinates are subjected to rotation and translation transformations to obtain grid coordinates of the obstacle contour points in the global map coordinate system, thereby determining the corresponding grid cells in the grid map where the obstacle contour points are located, and registering the obstacle contour points as hits on the corresponding grid cells in the grid map; and
wherein an rotation angle for the rotation transformation of the local coordinates is equal to an angle between coordinate axes of the robot coordinate system and the global map coordinate system, the coordinate axes being of a same orientation; and a translation amount for the translation transformation of the local coordinates is equal to a coordinate value of the robot's current position in the global map coordinate system.

6. The robot obstacle-avoidance control method according to claim 5, wherein the preset detection direction is parallel to the robot's axle, and the plurality of line segments are parallel to the preset detection direction; and
a positive direction of a vertical axis of the robot coordinate system is the same as the target planning direction, and a positive direction of a horizontal axis of the robot coordinate system is the same as the preset detection direction.

7. The robot obstacle-avoidance control method according to claim 5, wherein the operation of selecting the effective obstacle grid cell for each line segment, from among the grid cells traversed by the line segment that contain the corresponding obstacle contour points, based on the occupancy probability values corresponding to the grid cells traversed by the line segment comprises:
from among the grid cells traversed by each line segment that contain the corresponding obstacle contour points, selecting and marking a grid cell with the highest occupancy probability value along the line segment as the effective obstacle grid cell; and
forming an effective contour of the obstacle in the grid map using all effective obstacle grid cells corresponding to the plurality of line segments;
wherein coordinates of the effective obstacle grid cells represent the grid coordinates of the obstacle in the grid map.

8. The robot obstacle-avoidance control method according to claim 7, wherein after each obstacle contour point hits at least one grid cell of the grid cells of the grid map, the at least one hit grid cell is marked as the grid cell containing the obstacle contour point and is assigned a hit probability value; and
each time each obstacle contour point hits the corresponding grid cell, the pre-assigned hit probability value of the grid cell is cumulatively added to obtain the occupancy probability value of the grid cell, thereby updating the occupancy probability value of the grid cell according to a number of times the grid cell is hit by the obstacle contour point;
wherein the occupancy probability value is updated as the accumulated hit probability value.

9. The robot obstacle-avoidance control method according to claim 7, wherein before performing the curve fitting operation, the robot first converts the grid coordinates of the effective obstacle grid cells from the global map coordinate system back into the robot coordinate system using rotation transformation and translation transformation, thereby obtaining position coordinates of effective contour points; and
wherein between the global map coordinate system and the robot coordinate system, the rotation transformation of the grid coordinates of the effective obstacle grid cells is an inverse of the rotation transformation of the local coordinates, and the translation transformation of the grid coordinates of the effective obstacle grid cells is an inverse of the translation transformation of the local coordinates.

10. The robot obstacle-avoidance control method according to claim 9, wherein before the curve fitting operation is performed, when the position coordinates of the effective contour points are obtained, the robot causes the effective contour points to be translated in a direction opposite to the preset detection direction by a preset obstacle-avoidance margin, thereby obtaining fitting target points;
wherein the preset obstacle-avoidance margin is configured as a sum of the radius of the robot body and a predetermined obstacle-avoidance distance.

11. The robot obstacle-avoidance control method according to claim 10, wherein when the curve fitting operation is Bézier curve fitting, a start point and an end point of the Bézier curve are determined from among the fitting target points along the target planning direction;
the robot sequentially marks the fitting target points distributed between the start point and the end point along the target planning direction as intermediate points for fitting the Bézier curve; and
the fitted curve equation for obstacle-avoidance is generated based on the start point, the end point, and the intermediate points of the Bézier curve;
wherein a total number of the start point, end point, and intermediate points is equal to an order of the Bézier curve plus one; the order of the Bézier curve is denoted as n; and the end point of the Bézier curve corresponds to the predetermined obstacle-avoidance end point.

12. The robot obstacle-avoidance control method according to claim 11, wherein the fitted curve equation for obstacle-avoidance is:
$$\{ \begin{matrix}{B}_{x} ( t ) = {\sum }_{i = 0}^{n} ( \begin{matrix}n \\ i\end{matrix} ) {{P}_{i x} ( 1 - t )}^{n - i} {t}^{i} , t ∈ [ 0 , 1 ] \\ {B}_{y} ( t ) = {\sum }_{i = 0}^{n} ( \begin{matrix}n \\ i\end{matrix} ) {{P}_{i y} ( 1 - t )}^{n - i} {t}^{i} , t ∈ [ 0 , 1 ]\end{matrix} ;$$
wherein the fitted curve equation for obstacle-avoidance represents a trajectory equation for generating a fitted curve for obstacle-avoidance; Bₓ(t) is an abscissa of a point on the fitted curve for obstacle-avoidance, and B_{y}(t) is an ordinate of the point on the fitted curve for obstacle-avoidance; i denotes an index number of a control point required for generating the fitted curve for obstacle-avoidance, and t is a parameter equal to a ratio of i to (n+1);
wherein the start point, end point, and intermediate points of the Bézier curve are all control points used for the Bézier curve fitting; and
wherein Pᵢₓ denotes an abscissa of a fitting target point set as a control point Pᵢ, and P_{iy} denotes an ordinate of the fitting target point set as the control point Pᵢ; P₀ₓ and P_{0y} respectively denote an abscissa and an ordinate of the start point of the Bézier curve, and Pₙₓ and P_{ny} respectively denote an abscissa and an ordinate of the end point of the Bézier curve.

13. The robot obstacle-avoidance control method according to claim 12, wherein the operation of determining the start point and the end point of the Bézier curve from among the fitting target points comprises:
determining the start point of the Bézier curve as a fitting target point, from among all the fitting target points obtained by the effective obstacle grid cells selected after coordinate system transformation and translation, which has the smallest coordinate value in the target planning direction, thereby forming the fitting target point closest to the center of the robot body; and
determining the end point of the Bézier curve as a fitting target point, from among all the fitting target points obtained by the effective obstacle grid cells selected after coordinate system transformation and translation, which has the largest coordinate value in the target planning direction, thereby forming the fitting target point farthest from the center of the robot body.

14. The robot obstacle-avoidance control method according to claim 13, wherein the operation of calculating the obstacle-avoidance target point from the fitted curve equation for obstacle-avoidance based on the position point adjacent to the current position of the robot along the target planning direction comprises:
calculating a coordinate value of the position point adjacent to the current position along the target planning direction, and setting the coordinate value as a look-ahead ordinate; and
substituting the look-ahead ordinate into the fitted curve equation for obstacle-avoidance to compute an abscissa of a point on the fitted curve for obstacle-avoidance, an ordinate of the point being equal to the look-ahead ordinate, and marking such a point on the fitted curve for obstacle-avoidance as the obstacle-avoidance target point;
wherein a difference, between the coordinate value of the position point adjacent to the current position along the target planning direction and the coordinate value of the current position along the target planning direction, is equal to a preset parameter.

15. The robot obstacle-avoidance control method according to claim 14, wherein the operation of updating the current position of the robot to be the obstacle-avoidance target point each time the robot reaches the obstacle-avoidance target point, and repeating the operations of calculating the obstacle-avoidance target point and updating the current position of the robot until the robot reaches the predetermined obstacle-avoidance end point comprises:
each time the robot reaches one obstacle-avoidance target point, updating the current position of the robot to be the obstacle-avoidance target point where the robot is located, then executing the operation of calculating the obstacle-avoidance target point to calculate the next obstacle-avoidance target point, and then moving to the next obstacle-avoidance target point; updating the current position of the robot to be the next obstacle-avoidance target point, again executing the operations of calculating the obstacle-avoidance target point and updating the current position of the robot, and repeating the above process until the robot reaches the predetermined obstacle-avoidance end point, thereby enabling the robot to move along the fitted curve for obstacle-avoidance.

16. An obstacle-avoiding device, comprising:
a robot; and
a laser sensor mounted on the robot,
wherein the obstacle-avoiding device is configured to perform, via the robot and the laser sensor, the following operations:
controlling the laser sensor to perform rotational scanning, collecting one or more obstacle contour points of an obstacle, and obtaining, from a grid map, one or more grid cells in which the one or more obstacle contour points are located and one or more occupancy probability values respectively corresponding to the one or more grid cells;
establishing a plurality of line segments on a side of the robot proximate to the obstacle such that each line segment traverses one or more grid cells, containing one or more corresponding obstacle contour points of the obstacle contour points, of the grid cells;
for each line segment, selecting, from among the one or more grid cells traversed by the line segment that contain the one or more corresponding obstacle contour points, an effective obstacle grid cell based on one or more occupancy probability values corresponding to the one or more grid cells traversed by the line segment;
performing a curve fitting operation using the effective obstacle grid cell to generate a fitted curve equation for obstacle-avoidance;
calculating an obstacle-avoidance target point from the fitted curve equation for obstacle-avoidance based on a position point adjacent to a current position of the robot along a target planning direction, to cause the robot to travel from its current position to the obstacle-avoidance target point; and
updating the current position of the robot to be the obstacle-avoidance target point each time the robot reaches the obstacle-avoidance target point, and repeating the operations of calculating the obstacle-avoidance target point and updating the current position of the robot until the robot reaches a predetermined obstacle-avoidance end point.
